(19) United States
(12) Patent Application Publication
(10) Pub. No.: US 2004/0151063 A1
(43) Pub. Date: Aug. 5, 2004

(54) High-pressure mixing apparatus

(75) Inventor: Maurizio Corti, Como (IT)

Correspondence Address: YOUNG & THOMPSON, 745 SOUTH 23RD STREET 2ND FLOOR, ARLINGTON, VA, 22202

(73) Assignee: AFROS S. P. A., CARONNO PERTUSELLA-VARESE (IT)

(21) Appl. No.: 10/435,371

(22) Filed: May 12, 2003

(30) Foreign Application Priority Data
Feb. 5, 2003 (IT) MI2003A000187

(51) Int. Cl. B01F 13/00

(52) U.S. Cl. 366/162.5

(57) ABSTRACT

The apparatus comprises a high-pressure mixing headdevice and a manually operable valve assembly to stop the circulation of chemical components which are fed into a mixing chamber by injection nozzles, or are made to re-circulate, and to stop the pressurized oil fed to a hydraulic cylinder for controlling a cleaning member reciprocable in the mixing chamber. The mixing device is operatively and mechanically connected to the valve assembly, to enable its quick removal and replacement by closing the valves without disconnecting pipings from the valve unit, and without causing leakage of the chemical components and the oil, ensuring an extremely easy handling of the entire mixing apparatus.

### BACKGROUND OF THE INVENTION

This invention refers to a mixing apparatus for the production of chemically reactive mixtures, in particular for the production of polyurethane foams, which is suitable for filling cavities by the use of a high-pressure mixing device which is appropriately shaped to allow a quick and easy interchange-ability of the same mixing device without causing leakages of the chemical components and oil during replacement.

### STATE OF THE ART

A high-pressure mixing apparatus, of the conventional type, substantially comprises of a self-cleaning mixing head having a mixing chamber which extends into a delivery duct; an elongated cleaning member controlled by a hydraulic cylinder is reciprocable whitin the mixing chamber and the delivery duct between a rearward position in which it opens the mixing chamber and the delivery duct, and a forward position in which it closes the mixing chamber and the delivery duct causing the re-circulation of the chemical components so as to control their transient during setting of flow and pressure conditions.

A mixing head of this kind also comprises two or more injection nozzles for injecting the chemical components into the mixing chamber, each of which is connected to a feed duct for feeding a component, and respectively is connectable to a recirculating duct by means of a longitudinal slot in the cleaning member.

Mixing apparatuses of this kind are described in prior documents, for example in U.S. Pat. No. 4,070,008, U.S. Pat. No. 4,175,874, U.S. Pat. No. 4,332,335, and U.S. Pat. No. 5,540,497.

In all of the aforementioned documents, the mixing apparatus is substantially in the form of a single operative unit, to which the various feeding and re-circulating pipes are directly connected to the injection nozzles for the chemical components, respectively to the control cylinder for the cleaning member with which an usual high-pressure mixing apparatus is provided.

A mixing apparatus of the aforementioned kind consequently presents a configuration and a disposition of the various feeding and re-circulating pipes, which is somewhat complex and so much so as to make the apparatus rather unsuitable for certain applications which call for great ease of handling and the possibility of quickly disassembling and replacing the apparatus itself.

Numerous applications, for example in the automotive field for filling with polyurethane foam the cavities in structures of vehicles, require the use of mixing apparatuses which are extremely easy to handle, with a conical/cylindrical shape capable of gaining access to injection holes, and with a configuration designed to permit a quick disassembling of the apparatus without causing leakage or dripping of the chemical components fed to the nozzles.

In order to partially remedy the problems of cleaning and maintenance of high-pressure mixing apparatuses, U.S. Pat. No. 4,568,003 suggests the use of a mixing chamber which is detachably fastened to the body of the apparatus, to enable its quick removal and replacement.

However, this document also not only proposes a solution substantially of the conventional type, in which the various feeding pipes for the components are connected directly to their respective nozzles, in different parts of the apparatus, but the replacement of the mixing chamber require the disconnection of the cleaning member from the control cylinder, which therefore remains firmly secured to a support body for the same mixing chamber and the control cylinder.

Moreover, whenever the injection nozzles have to be cleaned or replaced, it is necessary to disconnect all the feeding pipes for the components, resulting in a considerable consuption of time and interruption of the work cycle. This would also cause dripping or leakage of liquids from the pipes, with a consequent soiling of the work environment.

### OBJECTS OF THE INVENTION

The main object of this invention is to provide an apparatus for the production of chemical reactive mixtures, in particular for the production of rigid or flexible polyurethane foams, comprising a high-pressure mixing device, of the self-cleaning type, by which it is possible to rapidly remove and replace the entire mixing device without having to disconnect the various pipes for feeding and re-circulating the chemical components, and the oil fed to a control cylinder for a cleaning member, which remain permanently connected to the apparatus, and without causing dripping or leakage of liquids and, consequently, without soiling the work environment.

A further object is to provide a high-pressure mixing apparatus which is extremely easy to handle and simple to use, due to a particular disposition of the pipe connections for the pipe lines.

A still further object of the invention is to provide a mixing apparatus of the aforementioned kind, which is capable of increasing its mixing efficiency, in particular whenever one of the chemical components is fed at considerably reduced flow rates, or in considerably reduced proportions as compared to another or to the other components, and consequently is unlikely to contribute, except to a very limited degree, to the dynamic mixing effect typical of apparatuses of this kind.

### BRIEF DESCRIPTION OF THE INVENTION

The above can be achieved by means of a high-pressure mixing apparatus for the production of a reactive mixture from at least a first and a second chemical component, the apparatus comprising:

a body member at a front side, said body member having a mixing chamber axially extending into a delivery duct;

at least a first and a second injection nozzle on said body member, for injecting the chemical components into the mixing chamber;

a control cylinder having a peripheral wall defining a piston chamber, and a piston member in said piston chamber to reciprocate a cleaning member the mixing chamber and the delivery duct; and

a valve unit at the rear side of the mixing apparatus for connection of the injection nozzle and control cylinder to feeding and recycling pipes, said valve unit comprising a plurality of manually actuable valve members; and

conduit means for fluid communication between each valve member of the valve unit and a respective injection nozzle of the mixing device.

According to one feature of the invention, the valve assembly and respective pipe fittings for connection to feeding and re-circulating pipes for the fluids, is totally integrated into a separate support body detachably connected to the control cylinder and said body member of the mixing device, enabling a quick and easy replacement of the latter, and the same control cylinder, without the release or leakage of the chemical components and/or the oil of the hydraulic control cylinder for the cleaning member.

According to a further feature of the invention, the conduit means for feeding to and recycling the components from the individual injection nozzles as well as for the pressurised oil, are provided into the peripheral wall of the hydraulic control cylinder and into the body member of the mixing chamber, to reduce the overall dimensions of the mixing device.

According to a still further feature of the invention, the injection nozzles for the chemical components slant backwards, towards the rear end of the mixing chamber, in order to increase the mixing efficiency.

The disposition of the various elements forming the mixing apparatus, therefore allows the quick removal and replacement of the body member comprising the mixing chamber, and the control cylinder, while maintaining connection of the valve unit to feeding and recycling pipes, and the entire apparatus limited in weight and extremely easy to use.

### BRIEF DESCRIPTION OF THE DRAWINGS

These and further features and advantages of the invention, will be more evident from the following description with reference to the accompanying drawings, in which:

FIG. 1 shows a side view of the mixing apparatus;

FIG. 2 shows a top view of the apparatus of FIG. 1;

FIG. 3 shows a longitudinal cross-sectional view along the line 3-3 of FIG. 2;

FIG. 4 shows a cross-sectional view in correspondence with the injection nozzles, along the line 4-4 of FIG. 3.

### DETAILED DESCRIPTION OF THE INVENTION

As shown in the various figures, the mixing apparatus according to the invention comprises a high-pressure mixing device, of the self-cleaning type, indicated by reference number 10, which is removably secured to a support body 11 for a valve unit, as specified further on. The support body 11 may consist in a circular plate provided, for example, with a handgrip 12 for manual operation, or with means for connection to a manipulator.

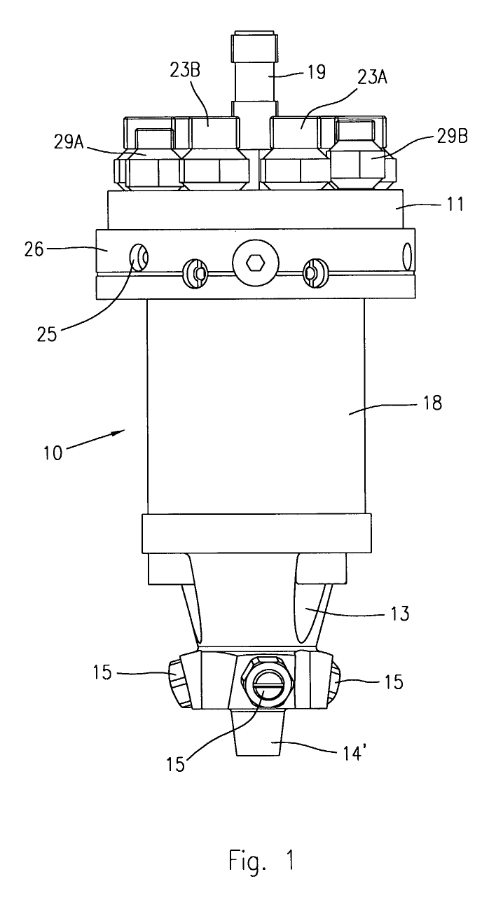

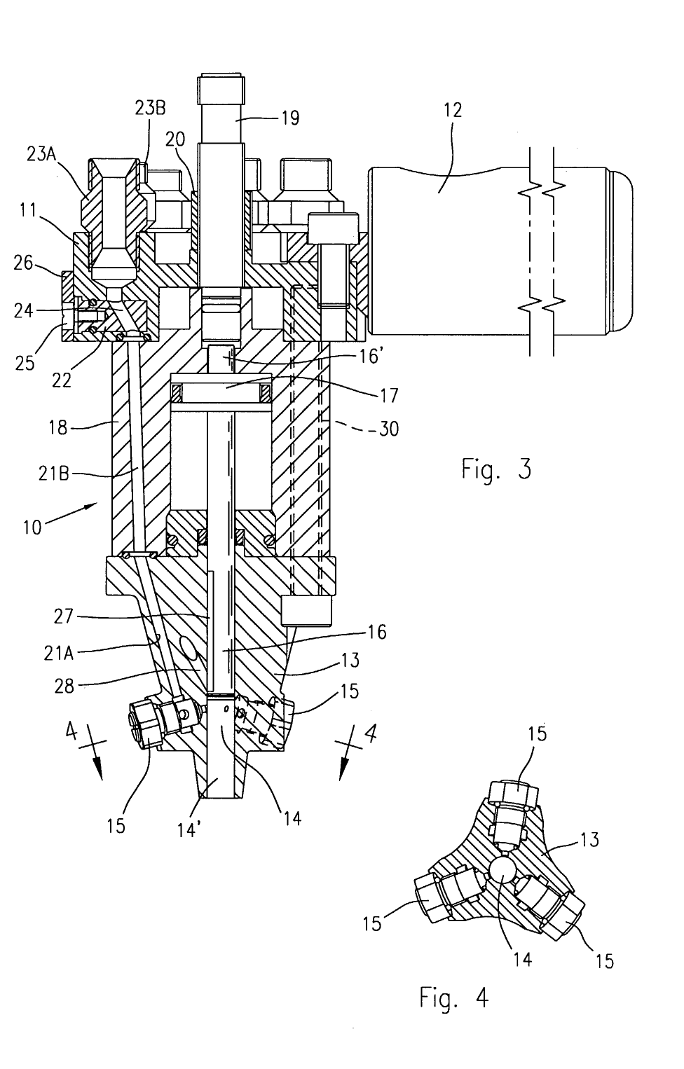

As shown in FIG. 1 and in the cross-sectional view of FIG. 3, the mixing device 10 comprises a conically shaped body 13 at the front end, provided with a longitudinal hole defining a cylindrical mixing chamber 14 which extends axially into a delivery duct 14′ for delivering the chemical mixture along a nose-shaped portion at its fore end.

The body 13 of the mixing device, is also provided with seats for housing two or more injection nozzles 15, three in the case shown, which are angularly spaced apart, for example at 120°, as shown in the cross-sectional view of FIG. 4.

Within and along the mixing chamber 14 and the delivery duct 14′, slides a cleaning member 16 substantially provided by an extension of the rod of the piston 17 of an intermediate hydraulic control cylinder 18 which forms part of the mixing device 10.

On the side opposite to the cleaning member 16, the piston rod 16 extends with a rear portion 16′ which operates in a per se known way a limit switch or a sensor 19 screwed into a housing 20, to provide a control signal at the opening of the mixing chamber 14.

Still with reference to the example shown in FIG. 3, it can be seen that each injection nozzle 15 communicates with a respective pipe fitting 23A for connection to a feed pipe for a chemical component, by means of a duct 21A in the body 13 of the mixing device, which extends rearward with a duct 21B in the peripheral wall of the hydraulic cylinder 18, towards a manually-operable on-off valve member 22 seated in the support plate 11, to stop the flow of the component, whenever the mixing device 10 must be removed and/or replaced.

The valve members 22 are in the form of a cylindrical plug rotatingly supported by the body 11 of the valve unit, and provided with a cross hole 24 to connect or respectively to close each pipe fitting 23A in the direction of the feed duct 21B and the respective injection nozzle. Each valve member 22 can be manually operated by inserting an appropriate tool, for example by inserting the tip of a screwdriver in a slot, through a hole 25 provided in a ring 26 outside of the body 11 for retaining all the on-off valve members 22.

Each injection nozzle 15 in the forward condition of the cleaning member 16, can also be connected to a recycling circuit for the chemical component, by means of a longitudinal slot 27 made into the cleaning member, and a recycling duct 28 in the body 13 of the mixing device, only partially shown in FIG. 3; the duct 28, in a similar way to the ducts 21A and 21B, extends rearward through the wall of the hydraulic cylinder 18, towards a corresponding valve member 22 and pipe fitting 23B for connection to a recycling pipe.

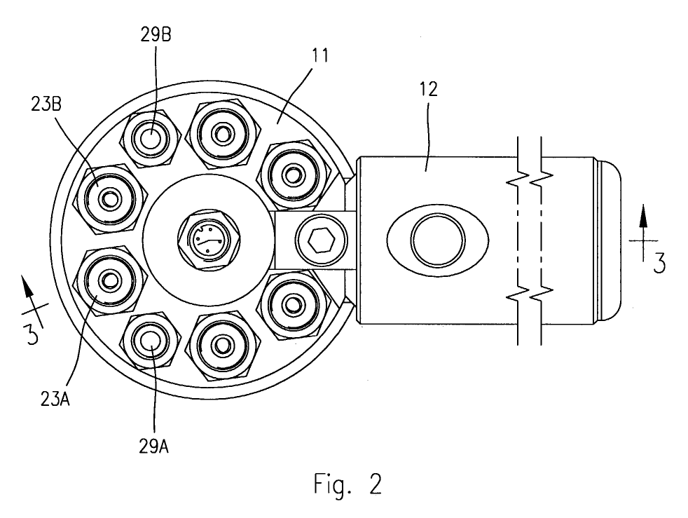

Although it has not been shown in the accompanying drawings, it is obvious that what has been described also applies to the remaining injection nozzles, including the hydraulic cylinder 18 which controls the cleaning member; also in this case, the pressurised oil is fed and discharged on both sides of the piston chamber, by means of feed ducts which extend into the peripheral wall of the control cylinder 18, and which connect to respective pipe fittings 29A and 29B, shown in FIG. 2, through corresponding on-off valves wholly similar to the on-off valves 22 for the individual chemical components.

From what has been previously described, it will therefore be evident that one of the features of the apparatus according to this mainly invention, resides in the functionally and structurally separable conformation and disposition of the mixing device 10 and the body 11 of the valve unit comprising the on-off valves 23A, 23B, 29A, 29B; another feature lies in the formation of the feeding and recycling ducts for the chemical components and pressurised oil, into the peripheral wall of the hydraulic cylinder 18 which actuates the cleaning member 16 of the mixing device 10.

This configuration and disposition of the various portions, offers an effective greater ease of handling and freedom of movement of the entire apparatus, in that all the flexible pipes which feed or re-circulate the chemical components, including the oil for the hydraulic control cylinder, are all positioned to the rear side of the mixing device 10 and the body 11 for the valve unit.

Furthermore, the conical shape of the fore portion 13 of the mixing device, terminating with a tapering nose facilitates the use of the apparatus allowing access even to delivery points which are difficult to reach with a conventional apparatus.

A further feature of the apparatus, consequential to the rear disposition of the on-off valve unit, and the formation of the feeling and recycling ducts into wall portions of the hydraulic control cylinder 18, consists in the possibility of operatively and mechanically connecting the mixing device 10 to the body 11 of the on-off valve assembly, in a wholly removable way, for example by means of a set of screws 30 which pass through corresponding holes in the front body 13 of the mixing device 10 and in the wall of the cylinder 18, and into threaded holes in the rear body 11.

According to a still further feature of the invention, as shown in FIG. 3, the injection nozzles 15 are slanted backwards towards the rear end of the mixing chamber 14 defined by the front end of the cleaning member 16, in its backward or retracted position.

The backward slanting of the nozzles 15 allows the flow of the components delivered by the nozzles, to be rearwardly injected, in order to greatly improve the dynamic mixing efficiency.

According to a further feature of the invention, a mixing apparatus has been provided for filling cavities with a polyurethane foam by means of a high-pressure mixing device, as previously described, comprising a first and a second nozzle for the injection of a pre-polymer, and respectively a third nozzle for the injection of a reactant, said injection nozzles for the pre-polymer and the reactant being angularly spaced apart from one another, the reactant being injected by said third nozzle, in a direction contrary to the flow of the mixture outcoming from the mixing chamber, and in a quantity ranging from 2% to 6% of the pre-polymer injected by said first and second injection nozzles of the mixing device.

From what has been described and shown it will be clear that the invention is directed to a high-pressure mixing apparatus having improved mixing efficiency, which is particular suitable for injecting a foam such as a polyurethane mixture also in points which are not easily accessible, for example in cavities in motor vehicles, or for any other application which call for great ease of handling, quick replacement of the mixing device and of the hydraulic control actuator, and at the same time avoiding soiling the work environment.

It is understood, therefore, that what has been described and shown with reference to the accompanying drawings, has been given purely by way of example to illustrate a preferential embodiment of the invention, and that other modification or variations can be made without thereby deviating from the scope of the accompanying claims.

What we claim is:

1. Mixing apparatus for the production of a reactive mixture from at least a first and a second chemical component, the apparatus comprising:
a body member at a front side, said body member having a mixing chamber axially extending into a delivery duct;
at least a first and a second injection nozzle on said body member, for injecting the chemical components into the mixing chamber;
a control cylinder having a peripheral wall defining a piston chamber, and a piston member in said piston chamber to reciprocate a cleaning member the mixing chamber and the delivery duct; and
a valve unit at the rear side of the mixing apparatus for connection of the injection nozzle and control cylinder to feeding and recycling pipes, said valve unit comprising a plurality of manually actuable valve members; and
conduit means for fluid communication between each valve member of the valve unit and a respective injection nozzle of the mixing device.

2. Mixing apparatus according to claim 1 wherein feeding and recycling ducts for the chemical components and pressurised oil extend in the wall of the hydraulic control cylinder.

3. Mixing apparatus according to claim 1 comprising a conically shaped body member at the front side of the mixing device, said body member having a narrow nose-shaped portion which extends beyond the injection nozzles at the mixing device.

4. Mixing apparatus according to claim 1 wherein the injection nozzles for the chemical components are rearwardly oriented in respect to the mixing chamber and the delivery duct.

5. Mixing apparatus according to claim 1 further comprising oil feeding ducts longitudinally extending into the wall of the control cylinder, between the piston chamber and respective on-off valves of the said valve assembly.

6. Apparatus for filling cavities with a polyurethane foam by means of a high-pressure mixing device, comprising:
a mixing chamber;
first and a second nozzles for injecting a pre-polymer, in said mixing chamber;
a third nozzle for injecting a reactant;
said injection nozzles for the pre-polymer and the injection nozzle for the reactant being angularly spaced apart from one another; the reactant being injected, by said third nozzle, in a direction opposite to the flow of the mixture outcoming from the mixing chamber, in a quantity ranging from 2% to 6% of the total pre-polymer injected by said first and second injection nozzles of the mixing device.
